(19) United States
(12) Patent Application Publication
(10) Pub. No.: US 2025/0368193 A1
(43) Pub. Date: Dec. 4, 2025

(54) CUSTOMIZED PILOT ASSIST

(71) Applicant: Volvo Car Corporation, Göteborg (SE)

(72) Inventors: Marcus Maxvall, Göteborg (SE); Filip Nielsen, Göteborg (SE); Mikael Törmänen, Göteborg (SE); Karolina Landin, Göteborg (SE)

(21) Appl. No.: 18/679,603

(22) Filed: May 31, 2024

(51) Int. Cl. B60W 30/09; B60W 30/18

(52) U.S. Cl. CPC B60W 30/09; B60W 30/18163; B60W 2420/40; B60W 2552/20; B60W 2554/802; B60W 2720/24

(57) ABSTRACT

A method for providing a customized pilot assist. The method includes capturing data on an external environment using the at least one perception sensor coupled to the vehicle, wherein the data comprises an observed lane on which the vehicle is traveling. The method further includes computing position information of the vehicle relative to the observed lane. The method further includes skewing a position of the vehicle relative to a center of the observed lane based on one or more skewing policies.

### INTRODUCTION

The present disclosure relates generally to the automotive field. Many vehicles that have pilot assist systems are able to assist a driver while driving. For example, most conventional lane keeping pilot assist systems keep a vehicle centered in an observed lane. However, it might not be optimal for a vehicle to be centered in an observed lane in all circumstances. For example, there may be scenarios when there are potentially hazardous conditions near the road such as obstacles.

The present introduction is provided as background context only and is not intended to be limiting in any manner. It will be readily apparent to those of ordinary skill in the art that the concepts and principles of the present disclosure may be implemented in other applications and contexts equally.

### SUMMARY

The present disclosure relates to a system for avoiding vehicle collisions. As described in more detail herein, embodiments provide customized pilot assist that safely positions a vehicle at an optimal position on an observed lane while traveling. A system captures data on the external environment using one or more perception sensors coupled to the vehicle. The captured data includes an observed lane on which the vehicle is traveling, as well as other external elements such as objects on the side of the road, road switchbacks, etc. The system computes position information of the vehicle relative to the observed lane, and skews the position of the vehicle relative to a center of the observed lane based on one or more skewing policies.

In one illustrative embodiment, the present disclosure provides a vehicle including: at least one perception sensor coupled to the vehicle; and a system comprising one or more processors and logic encoded in one or more non-transitory computer-readable storage media for execution by the one or more processors. The logic when executed is operable to cause the one or more processors to perform operations comprising: capturing data on an external environment using the at least one perception sensor, wherein the data comprises an observed lane on which the vehicle is traveling; computing position information of the vehicle relative to the observed lane; and skewing a position of the vehicle relative to a center of the observed lane based on one or more skewing policies. Optionally, in some embodiments, the logic when executed is further operable to cause the one or more processors to perform operations comprising: detecting at least one object that is positioned on a side of the observed lane based on the data that is captured; and estimating a location of the at least one object relative to the side of the observed lane, wherein at least one skewing policy of the one or more skewing policies comprises skewing the position of the vehicle off of the center of the observed lane and away from the at least one object based on a distance of the at least one object from the side of the observed lane. In some embodiments, at least one skewing policy of the one or more skewing policies comprises skewing the position of the vehicle off of the center of the observed lane and away from at least one object that is positioned on a side of the observed lane, wherein the at least one object is one or more of a hazardous object, a construction zone, a barrier, and a person. In some embodiments, the logic when executed is further operable to cause the one or more processors to perform operations comprising: detecting at least one road switchback ahead of the vehicle; and determining road switchback characteristics of the at least one road switchback, wherein at least one skewing policy of the one or more skewing policies comprises skewing the position of the vehicle off of the center of the observed lane and toward an inside of a curve of the observed lane based on the road switchback characteristics. In some embodiments, the logic when executed is further operable to cause the one or more processors to perform operations comprising: detecting at least one road switchback ahead of the vehicle; and determining road switchback characteristics of the at least one road switchback, wherein the road switchback characteristics comprise one or more of a road curvature and a road grade. In some embodiments, the logic when executed is further operable to cause the one or more processors to perform operations comprising receiving route information in association with a starting point and a destination point of vehicle, wherein at least one skewing policy of the one or more skewing policies comprises skewing the position of the vehicle off of the center of the observed lane based on the route information. In some embodiments, at least one skewing policy of the one or more skewing policies comprises skewing the position of the vehicle off of the center of the observed lane based on one or more road conditions.

In a further illustrative embodiment, the present disclosure provides a non-transitory computer-readable storage medium with program instructions stored thereon. The program instructions when executed by one or more processors are operable to cause the one or more processors to perform operations including: capturing data on an external environment using the at least one perception sensor coupled to the vehicle, wherein the data comprises an observed lane on which the vehicle is traveling; computing position information of the vehicle relative to the observed lane; and skewing a position of the vehicle relative to a center of the observed lane based on one or more skewing policies. Optionally, in some embodiments, the instructions when executed are further operable to cause the one or more processors to perform operations comprising: detecting at least one object that is positioned on a side of the observed lane based on the data that is captured; and estimating a location of the at least one object relative to the side of the observed lane, wherein at least one skewing policy of the one or more skewing policies comprises skewing the position of the vehicle off of the center of the observed lane and away from the at least one object based on a distance of the at least one object from the side of the observed lane. In some embodiments, at least one skewing policy of the one or more skewing policies comprises skewing the position of the vehicle off of the center of the observed lane and away from at least one object that is positioned on a side of the observed lane, wherein the at least one object is one or more of a hazardous object, a construction zone, a barrier, and a person. In some embodiments, the instructions when executed are further operable to cause the one or more processors to perform operations comprising: detecting at least one road switchback ahead of the vehicle; and determining road switchback characteristics of the at least one road switchback, wherein at least one skewing policy of the one or more skewing policies comprises skewing the position of the vehicle off of the center of the observed lane and toward an inside of a curve of the observed lane based on the road switchback characteristics. In some embodiments, the instructions when executed are further operable to cause the one or more processors to perform operations comprising: detecting at least one road switchback ahead of the vehicle; and determining road switchback characteristics of the at least one road switchback, wherein the road switchback characteristics comprise one or more of a road curvature and a road grade. In some embodiments, the instructions when executed are further operable to cause the one or more processors to perform operations comprising receiving route information in association with a starting point and a destination point of vehicle, wherein at least one skewing policy of the one or more skewing policies comprises skewing the position of the vehicle off of the center of the observed lane based on the route information. In some embodiments, at least one skewing policy of the one or more skewing policies comprises skewing the position of the vehicle off of the center of the observed lane based on one or more road conditions.

In a further illustrative embodiment, the present disclosure provides a computer-implemented method for providing a customized pilot assist, the method comprising: capturing data on an external environment using the at least one perception sensor coupled to the vehicle, wherein the data comprises an observed lane on which the vehicle is traveling; computing position information of the vehicle relative to the observed lane; and skewing a position of the vehicle relative to a center of the observed lane based on one or more skewing policies. Optionally, in some embodiments, the method further includes: detecting at least one object that is positioned on a side of the observed lane based on the data that is captured; and estimating a location of the at least one object relative to the side of the observed lane, wherein at least one skewing policy of the one or more skewing policies comprises skewing the position of the vehicle off of the center of the observed lane and away from the at least one object based on a distance of the at least one object from the side of the observed lane. In some embodiments, at least one skewing policy of the one or more skewing policies comprises skewing the position of the vehicle off of the center of the observed lane and away from at least one object that is positioned on a side of the observed lane, wherein the at least one object is one or more of a hazardous object, a construction zone, a barrier, and a person. In some embodiments, the method further includes: detecting at least one road switchback ahead of the vehicle; and determining road switchback characteristics of the at least one road switchback, wherein at least one skewing policy of the one or more skewing policies comprises skewing the position of the vehicle off of the center of the observed lane and toward an inside of a curve of the observed lane based on the road switchback characteristics. In some embodiments, the method further includes: detecting at least one road switchback ahead of the vehicle; and determining road switchback characteristics of the at least one road switchback, wherein the road switchback characteristics comprise one or more of a road curvature and a road grade. In some embodiments, the method further includes receiving route information in association with a starting point and a destination point of vehicle, and wherein at least one skewing policy of the one or more skewing policies comprises skewing the position of the vehicle off of the center of the observed lane based on the route information.

### BRIEF DESCRIPTION OF THE DRAWINGS

The present disclosure is illustrated and described with reference to the various drawings, in which like reference numbers are used to denote like assembly and/or system components and/or method steps, as appropriate.

FIG. 1 is a top-view block diagram of an example environment including a vehicle traveling on a road.

FIG. 2 is a flow chart for providing customized pilot assist.

FIG. 3 is a flow chart for providing customized pilot assist for driving safely past obstacles on the side of a road.

FIG. 4 is a top-view block diagram of an example external environment, where a vehicle is traveling on a skewed lane position on an observed lane while approaching an object on the side of a road.

FIG. 5 is a flow chart for providing a customized pilot assist for driving safely on switchbacks of a road.

FIG. 6 is a top-view block diagram of an example external environment, where a vehicle is traveling on a skewed lane position on an observed lane while approaching a road switchback.

FIG. 7 is a block diagram of an environment, showing a perspective toward the front of a vehicle.

FIG. 8 is a block diagram of an example high-level architecture for providing a customized pilot assist.

FIG. 9 is a block diagram of an example network environment of the present disclosure.

FIG. 10 is a block diagram of an example computing system of the present disclosure.

### DETAILED DESCRIPTION

Embodiments described herein provide customized pilot assist that safely positions a vehicle at an optimal position on an observed lane while traveling. As described in more below, a system captures data on the external environment using one or more perception sensors coupled to the vehicle. The captured data includes an observed lane on which the vehicle is traveling, as well as other external elements such as objects on the side of the road, road switchbacks, etc. The system computes position information of the vehicle relative to the observed lane. The system skews the position of the vehicle off center to one side or the other relative to the center of the observed lane based on one or more skewing policies.

As described in more detail below, the system skews a vehicle to a skewed position on an observed lane to accommodate objects that are present either temporarily or permanently near the side of the observed lane, and to accommodate other scenarios such as driving on road switchbacks, etc. Such pilot assist functionality has similarities to adaptive cruise control where a following distance is dynamic. In various embodiments, the amount of skewing within a given observe lane is dynamic depending on the particular implementation and scenario.

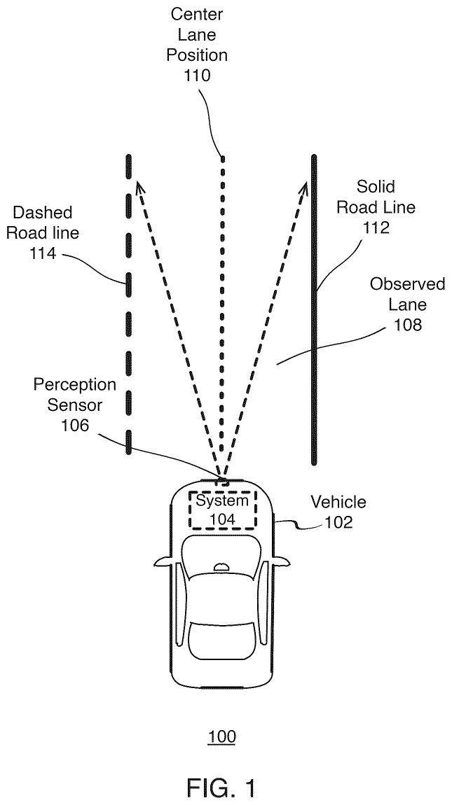

FIG. 1 is a top-view block diagram of an example environment 100 including a vehicle 102 traveling on a road. In various embodiments, the vehicle 102 has a system 104 and one or more perception sensors such as perception sensor 106 that are coupled to the vehicle 102. In the example embodiment shown, the perception sensor 106 is coupled to the front exterior of the vehicle 102. The perception sensor 106 may be coupled to the bumper of the vehicle 102 or to the grill of the vehicle 102. Further example embodiments directed to the perception sensors of the vehicle 102 are described in more detail herein.

As shown, the vehicle 102 is traveling on an observed lane 108 of a road. Also, the vehicle 102 is traveling in the center portion of the observed lane 108, or on a center lane position 110. Also shown are a solid road line 112 and a dashed road line 114. The solid road line 112 demarcates the road including the observed lane 108 from the shoulder of the road. The dashed road line 114 demarcates the observed lane 108 from other lanes of the road. For example, in various embodiments, the lane to the adjacent left of the observed lane 108 may be a lane designated for vehicles traveling in the opposite direction as the vehicle 102. In another example embodiment, the lane to the adjacent left of the observed lane 108 may be another lane designated for vehicles traveling in the same direction as the vehicle 102.

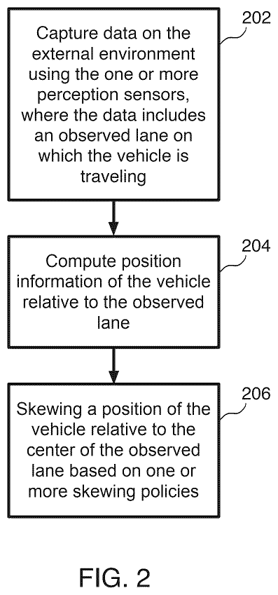

As described in more detail below in connection with FIG. 2, the system 104 captures data on the external environment using one or more perception sensors such as the perception sensor 106. The data that is captured by the perception sensors includes the observed lane 108 on which the vehicle 102 is traveling. The captured data may also include the area surrounding the observed lane (e.g., to the right and to the left of the observed lane 108). For example, the field of view of the perception sensor 106 (indicated by the dashed arrows) extends to the right past the solid road line 114 and extends to left past the dashed road line 114. The field of view of the perception sensor 106 may vary, depending on the particular implementation. Also, other perception sensors (not shown) that are situated around the vehicle 102 capture data in corresponding fields of view of those perception sensors in different directions (e.g., 360 degrees, etc.).

As described in more detail below, the system 104 processes the captured data to compute position information of the vehicle 110 relative to the observed lane 108, and skews the position of the vehicle 110 relative to the center of the observed lane or the center position 110 based on one or more skewing policies. Example embodiments directed to the captured data, positional information, and the skewing policies are described in more detail herein.

In various embodiments, the perception sensors may be positioned at various locations on the exterior and the interior of the vehicle 102. As indicated above, the perception sensor 106 is positioned at the front of the vehicle 102 (e.g., at the bumper or grill). In various embodiments, perception sensors may be positioned at the left side of the vehicle 102, at the right side of the vehicle 102, and at the rear of the vehicle 102 (e.g., on the bumper or above the bumper).

Being positioned on or at the exterior portion of the vehicle 102 means that at least one portion of a perception sensor such as a lens is exposed to the environment 100, or external environment 100. In various embodiments, one or more perception sensors may be positioned at interior portions of the vehicle. For example, one or more of the perception sensors may be positioned inside the vehicle with views through one or more windows (e.g., behind the front windshield, near the rear-view mirror, etc.). As such, the perception sensors capture various types vantage points as well as various types of data associated with the external environment 100.

The actual number of perception sensors positioned on the exterior of the vehicle 102 or in the interior the vehicle 102 may vary, depending on the particular implementation. Also, the positions or locations of the perception sensors on the vehicle 102 may vary, depending on the particular implementation. For example, one or more perception sensors maybe positioned or mounted on the roof of the vehicle 102, underneath the vehicle 102, etc.

As indicated above, the perception sensors function to capture data on the surrounding external environment 100. Such data may also include objects such as other vehicles, objects on the side of the road such as people, animals, road barriers, construction equipment, natural elements such as trees and boulders, as well as weather elements such as rain, snow, etc. As described in more detail below, the data captured may also include road characteristics such as the direct and turns in the road. Further embodiments directed to the perception sensors and data captured are described in more detail herein.

In various embodiments, the system 104 may utilize multiple types of perception sensors to capture data on the external environment 100. Any sensing methodology may be used, and the particular sensing methodology will depend on the particular implementation. For example, in various embodiments, one or more perception sensors may include one or more image sensing perception sensors or cameras, radar detectors, light detection and ranging (Lidar) cameras, and/or ultrasonic cameras, or any combination thereof. The system may utilize image sensing perception sensors or cameras and/or infrared (IR) perception sensors or cameras and/or radar perception sensors or cameras.

Various perception sensors are described herein in the context of image sensing perception sensors such as cameras, etc., to assist the driver while driving. In various embodiments, the system may utilize any one or more of these perception sensors and/or other types of sensors and cameras to collect data described herein. For example, such collected data may include data on any objects outside of the vehicle 102, including objects on the road. For example, such objects may include road surface features (e.g., bumps, potholes, etc.), environmental features (e.g., trash, alive or dead animals, rocks, boulders, etc.). Such objects may also include other vehicles or people. The data may include Lidar data and well as images. The images may be a continuous series of images, which may include video.

In various embodiments, the perception sensors of the vehicle 102 may be referred to as client devices, which may communicate with the system 104. Such communications may be facilitated via any suitable communication network (not shown) such as a wired network, a Bluetooth network, a Wi-Fi network, etc., or any combination thereof.

For ease of illustration, FIG. 1 shows one block for the system 104 and one block for perception sensor 106. Each of these blocks may represent multiple systems and perception sensors. In other implementations, environment 100 may not have all of the components shown and/or may have other elements including other types of elements instead of, or in addition to, those shown herein.

While the system 104 performs implementations described herein, in other implementations, any suitable component or combination of components associated with the system 104 or any suitable processor or processors associated with the system 104 may facilitate performing the implementations described herein.

FIG. 2 is a flow chart for providing customized pilot assist. Referring to both FIG. 1 and FIG. 2, a method is initiated at block 202, where a system such as the system 104 captures data on the external environment using the one or more perception sensors coupled to the vehicle 102 such as perception sensor 106. As indicated above, in connection with FIG. 1, perception sensors such as the perception sensor 106 are disposed or situated around the vehicle 102. This enables system 104 to collect data on the surrounding external environment, including collecting data captured in association with the observed lane 108 and objects on the side of the observed lane 108.

In various embodiments, the data that is captured by perception sensors such as the perception sensor 106 includes the observed lane 108 on which the vehicle 102 is traveling. As indicated above, the captured data also includes areas surrounding the observed lane 108 such as objects to the side of the observed lane 108. As such, in various embodiments, the system 104 detects one or more objects that are positioned on the side of the observed lane 108 based on the data that is captured.

At block 204, the system 104 computes position information of the vehicle 102 relative to the observed lane 108. In the example scenario shown in FIG. 1, the vehicle 102 is traveling at the center lane position 110. The system 104 may determine that the vehicle 102 is traveling at the center lane position 110 based on the current position of the vehicle 102 relative to the solid road line 112 and relative to the dashed road line 114, which the perception sensor 106 captures in its field of view. The system 104 may also utilize other perception sensors positioned at the right side of the vehicle 102 and directed toward the solid road line 112 and perception sensors positioned to the left side of the vehicle 102 and directed toward the dashed road line 114 to determine the location of the vehicle 102 relative to the observed lane 108.

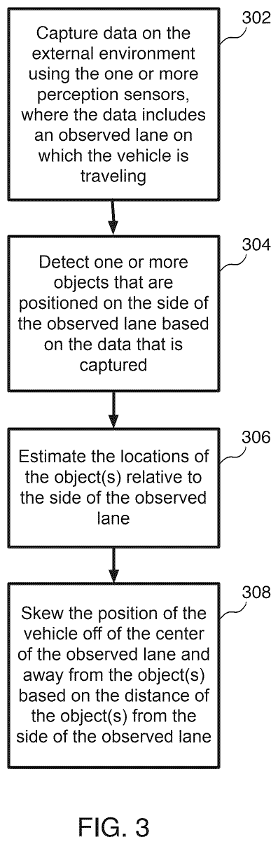

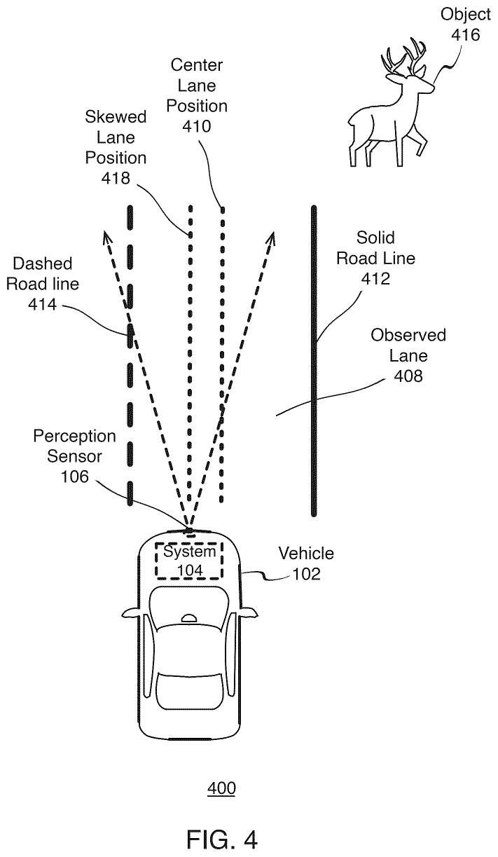

As indicated above, the system 104 also detects one or more objects that are positioned on the side of the observed lane 108 based on the data that is captured. In various embodiments, the system 104 processes the data associated with the one or more objects, and the system 104 estimates the location of the one or more objects relative to the side of the observed lane. Example embodiments directed to detected objects are described in more detail below, in connection with FIGS. 3 and 4, for example.

At block 206, the system 104 skews the position of the vehicle 102 relative to the center of the observed lane 108 based on one or more skewing policies. Example embodiments directed to the detection of objects that are positioned to the side of the observed lane are described in more detail below, in connection with FIGS. 3, 4, 5, and 6, for example.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

FIG. 3 is a flow chart for providing customized pilot assist for driving safely past obstacles on the side of a road. Referring to both FIG. 1 and FIG. 3, a method is initiated at block 302, where a system such as the system 104 captures data on the external environment using the one or more perception sensors coupled to the vehicle 102 such as perception sensor 106. As indicated above, in various embodiments, the data that is captured by perception sensors includes the observed lane 108 on which the vehicle 102 is traveling, as well as areas surrounding the observed lane 108 including objects to the side of the observed lane 108.

At block 304, the system 104 detects one or more objects that are positioned on the side of the observed lane 108 based on the data that is captured. In various embodiments, the system 104 may detect objects based on one or more images of the objects captured by one or more perception sensors such as perception sensor 106. Further example embodiments directed to the detection of objects that are positioned to the side of the observed lane are described in more detail below, in connection with FIG. 4, for example.

FIG. 4 is a top-view block diagram of an example external environment 400, where the vehicle 102 is traveling on a skewed lane position on an observed lane 408 while approaching an object on the side of the road. Similar to FIG. 1, the vehicle 102 includes the system 104, and the perception sensor 106, as well as other perception sensors (now shown). Also shown is a center lane position 410, a solid road line 412, and a dashed road line 414.

In the example scenario shown, an object 416 is positioned at the side of the observed lane. Here, the object 416 is a deer that is standing to the right of the solid road line 412. The deer or object 416 is a potentially hazardous obstacle, because it is close to the observed lane 408, and could walk onto the observed lane 408 and into the path of the vehicle 102. As such, in this scenario, as the vehicle 102 continues traveling on the observed lane 408 and generally toward the object 416, the vehicle 102 is at risk of hitting the object 416 or deer, if the deer were to walk in front of the vehicle 102 before the vehicle could drive around or stop before reaching the deer.

The deer or object 416 may represent other types of hazardous obstacles, including other types of animals, trash, rocks, boulders, trees, road barriers, other vehicles, people, etc. These are objects that the driver of the vehicle 102 might not see due to poor visibility or other factors such as being distracted by a mobile device or another person in the vehicle 102. As such, there is also a risk of the vehicle 102 drifting to the right and hitting an object that remains to the side of the observed lane 408, yet is positioned dangerously close to the solid road line 412. Also, when driving by construction zone where there is an increased risk of the vehicle 102 hitting a barrier, construction equipment, or construction workers, etc., the system will similarly skew the path of the vehicle 102 from the center lane position 410 to a safter skewed lane position 418.

In various embodiments, the system may also fetch crowdsourced data on potentially hazardous obstacles that are close to observed lane 408. For example, the system may fetch crowdsourced data from other drivers who report potentially hazardous obstacles on the road. Crowdsourced data may be vehicle-to-vehicle (V2V) data. The system may also collect vehicle-to-infrastructure (V2I) data such as map data from the cloud and use global positioning system (GPS) technology to determine where the vehicle is located on a given road that has a reported hazardous object. In some embodiments, the system may be configured to report hazardous objects that the system detects and identifies to crowdsourcing applications.

In various embodiments, the system may use artificial intelligence (AI) and machine learning to track known objects that could cause damage to a vehicle on specific roads or parking areas. In some scenarios, some objects may be objects that are not inherently hazardous obstacles, yet are potentially hazardous based on the motion of the vehicle and the risk of driving into such obstacles. For example, such objects may also include permanently placed objects such as road barriers, boulders, trees, etc.

At block 306, the system 104 estimates the locations of the one or more objects relative to the side of the observed lane 408. Here, the side of the observed lane 408 is the solid road line 412, and the object in question is the object 416 (the deer). In various embodiments, the system 104 may use Lidar techniques to estimate the locations of objects positioned to the side of the observed lane 408. The system 102 also computes the estimated location of a given object such as the object 416 in relation to the solid road line 412. As described in more detail herein, the system 102 warns or alerts the driver of any objects that are dangerously close to the observed lane 408 and thus potentially hazardous obstacles such as the object 416.

As indicated above, the system 104 skews the position of the vehicle 102 relative to the center of the observed lane or the center lane position 410 based on one or more skewing policies. In various embodiments, at least one of the skewing policies includes skewing the position of the vehicle off of the center of the observed lane and away from the one or more objects that are positioned on the side of the observed lane.

At block 308, the system 104 skews the position of the vehicle 102 off of the center of the observed lane (e.g., off of the center lane position 410) and away from the one or more objects (e.g., away from the object 416) based on a distance of the one or more objects from the side of the observed lane (e.g., from the solid road line 412). For example, if the object 416 is close to the solid road line 412 yet several feet away, the system 104 may skew the position of the vehicle 102 to the left of the center lane position 410 by a smaller amount (e.g., 6 inches, 9 inches, etc.). If the object 416 is close to the solid road line 412 yet less than a foot away, the system 104 may skew the position of the vehicle 102 to the left of the center lane position 410 by a larger amount (e.g., 12 inches, 18 inches, etc.). The amount of skewing may vary and will depend on the particular implementation.

In various embodiments, the system 104 skews the position of the vehicle 102 automatically without driver intervention. For example, the system 104 takes control of the steering of the vehicle 102 to automatically steer the vehicle 102 to a safe position relative to the center lane position 410 and away from the object 416.

In various embodiments, the system 104 may determine an appropriate new position such as the skewed lane position 418 without risking hitting or coming close to hitting other surrounding vehicles. For example, before skewing to a new lane position away from the object 416, the system 104 may first determine the locations of any other surrounding vehicles to ensure that the vehicle 102 remains at a safe distance from other vehicles. In some embodiments, the system 104 may also slow down the vehicle 102 as needed to ensure that it drives safely past the obstacle 416.

As shown, the system 104 skews the position of the vehicle 102 from the center lane position 410 to the skewed lane position 418. As such, the vehicle 102 is traveling at a safer distance away from the object 416 in order to reduce the risk of hitting the object 416. The object 416 is shown as a deer for illustrative purposes. As indicated above, in various embodiments, objects on the side of the observed lane 408 may be of various types. For example, objects may also include other animals such as dogs, etc. Objects may also include one or more hazardous objects, a construction zone, one or more barriers, one or more people, etc.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

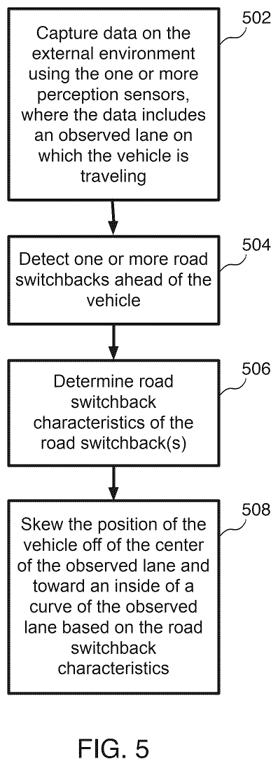

FIG. 5 is a flow chart for providing a customized pilot assist for driving safely on switchbacks of a road. Referring to both FIG. 1 and FIG. 5, a method is initiated at block 502, where a system such as the system 104 captures data on the external environment using the one or more perception sensors coupled to the vehicle 102 such as perception sensor 106. As indicated above, in various embodiments, the data that is captured by perception sensors includes the observed lane 108 on which the vehicle 102 is traveling, as well as areas surrounding the observed lane 108 including objects to the side of the observed lane 108.

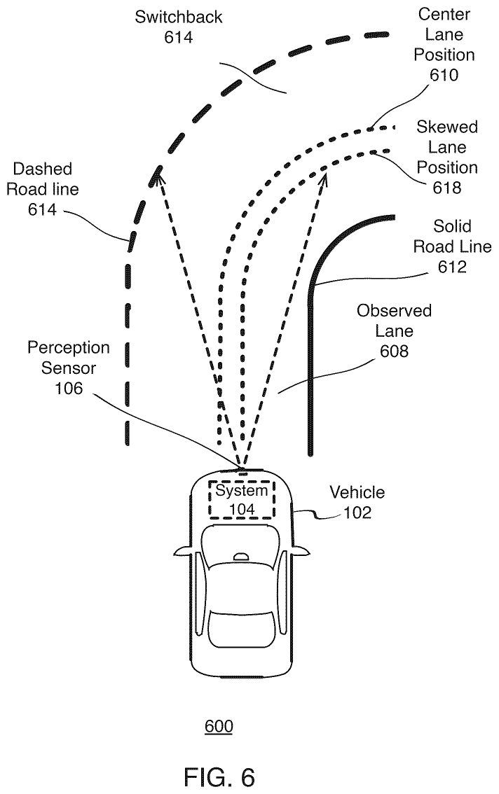

At block 504, the system 104 detects one or more road switchbacks ahead of the vehicle 102. In various embodiments, the system 104 may detect road switchbacks based on one or more images of the road switchbacks captured by one or more perception sensors such as perception sensor 106. Example embodiments directed to the detection of one or more switchbacks of a road are described in more detail below, in connection with FIG. 6, for example.

FIG. 6 is a top-view block diagram of an example external environment 600, where the vehicle 102 is traveling on a skewed lane position on an observed lane 608 while approaching a road switchback. Similar to FIG. 1, the vehicle 102 includes the system 104, and the perception sensor 106, as well as other perception sensors (now shown). Also shown is a center lane position 610, a solid road line 612, and a dashed road line 614. In this scenario, a skewed lane position 618 is to the right of the center lane position 610 or toward the inside of the curve of the observed lane 608. As describe in more detail below, this positioning of the skewed lane position 618 relative to the center lane position 610 is relevant to a road switchback scenario.

In various embodiments, the system 104 may detect or determine that the vehicle 102 is approaching a road switchback in various ways. For example, in some embodiments, one or more perception sensors of the system 104 may detect road markers or indicators (e.g., road signs, road lines, etc.) that indicate a road switchback coming up. For example, the perception sensor 106 may detect based on one or more images that the solid road line 612 and/or the dashed road line 614 are turning sharply to the right. In another example, a perception sensor such as the perception sensor 106 may detect a road sign indicating that one or more switchbacks are approaching.

In various embodiments, the system utilizes any suitable AI model, including AI, machine learning, and computer vision techniques to determine the curve of the observed lane based on one or more images of the shape of the road that one or more perception sensors capture ahead of the vehicle 102. In some embodiments, the system 104 may collect map data from the cloud and use GPS technology to determine where the vehicle is located on a given road, and determine the vehicle path 110 based on the map and GPS position of the vehicle.

At block 506, the system 104 determines road switchback characteristics of the one or more road switchbacks. In various embodiments, the road switchback characteristics may include the road curvature. For example, the system may process images of the observed lane 608 to identify changes in the road curvature, including the rate of change of the road curvature. In various embodiments, the road switchback characteristics may include the road grade. For example, the system may process images of the observed lane 608 to identify changes in the road grade, including the rate of change of the road grade.

As indicated above, the system 104 skews the position of the vehicle 102 relative to the center of the observed lane or the center lane position 610 based on one or more skewing policies. In various embodiments, at least one of the skewing policies includes skewing the position of the vehicle 102 off of the center of the observed lane and toward the inside of the curve of the observed lane based on the road switchback characteristics.

At block 508, the system 104 skews the position of the vehicle 102 off of the center of the observed lane 608 (e.g., off of the center lane position 610) and toward an inside of the curve of the observed lane 608 (e.g., on the skewed lane position 618) based on the road switchback characteristics. For example, if the curve of the switchback is smaller, the skewed lane position 618 may be further inside of the curve of the observed lane 608. This keeps the vehicle 102 at a safter distance from other vehicles on the road switchback that are traveling in the opposite direction, which may be hard to see. If the road grade is less, the skewed lane position 618 may be more inside of the curve of the observed lane 608. This provides a buffer in the event of some skidding by the vehicle 102. In various embodiments, the system may also slow the vehicle 102 down for added safety. These adjustments to the position of the vehicle 102 increase the safety while the vehicle 102 travels along the road switchbacks.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

In various embodiments, the system 104 may receive route information in association with a starting point and a destination point of vehicle. In various embodiments, at least one of the skewing policies includes skewing the position of the vehicle 102 off of the center of the observed lane based on the route information. For example, the route information may include information in associated with objects and road switchbacks. As such, the system 104 utilize the road information in combination with tracking the external environment using perception sensors.

In various embodiments, at least one of the skewing policies includes skewing the position of the vehicle 102 off of the center of the observed lane based on one or more road conditions. The system 104 may skew the position of the vehicle 102 away from the center lane position to an appropriate skewed lane position as needed and without driver intervention along the travel route. For example, during snowy or wet conditions, the system 104 may skew the position of the vehicle 102 away from patches of snow, water pooling, etc. This minimizes the risk of accidents and thereby increases safety of travel.

While some embodiments are described herein in the context of skewing a vehicle away from a center lane position, these embodiments may also apply to skewing a vehicle away from other lane positions to a safter skewed lane position. For example, in some regions where roads may have heavy snow, tire or wheel tracks may be formed in the snow on an observed lane from traffic. In the event of an obstacle near the observed lane or in the event of the presence of road switchbacks, the system may skew a vehicle away from the tire or wheel tracks to a safter skewed lane position similarly to other embodiments described herein.

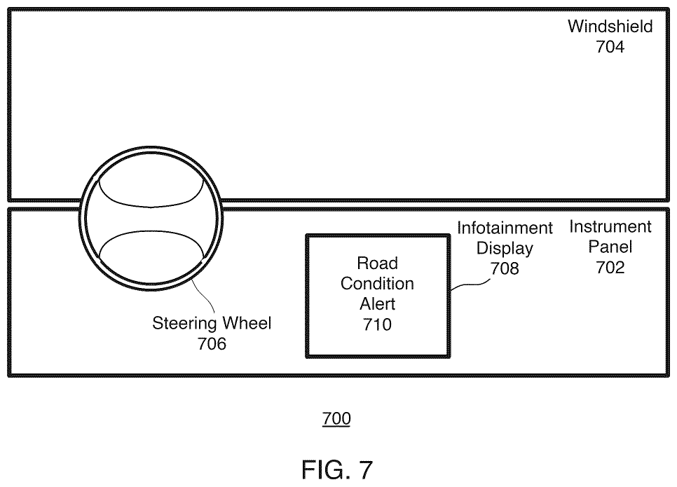

As described in more detail below, in connection with FIG. 7, the system 104 may communicate information such as obstacles and road switchbacks to the driver of the vehicle 102 via an infotainment system of the vehicle 102. Such information may be conveyed visually and/or auditorily by the infotainment system of the vehicle 102, depending on the particular implementation.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

FIG. 7 is a block diagram of an environment 700, showing a perspective toward the front of a vehicle, such as the vehicle 102 of FIGS. 1 and 2. Shown is a dashboard or instrument panel 702, a windshield 704, a steering wheel 706, and an infotainment display 708 of the infotainment system.

In various embodiments, when the system automatically alerts the driver of the vehicle 102 of any needed skewing of the vehicle 102 from the center position to a skewed position on an observed lane. The system 104 may display a road condition alert 710 on the infotainment display 708 before and/or during the skewing of the vehicle 102. In various embodiments, the road condition alert 710 may be any words indicating a warning of any skewing due to any potentially risky road conditions. The system may, for example, indicate the driver the purpose for skewing the vehicle path (e.g., “Potentially hazardous object near the side of the road!”, “Approaching a road switchback!”, etc.). In some embodiments, the road condition alert 710 may be accompanied by an audio alert that is delivered auditorily via the speaker system of the infotainment system.

In various embodiments, with pilot assist on, the system 104 may enable the driver to customize settings for skewing the vehicle 102 at varying amounts for different circumstances. For example, this may be accomplished via the infotainment system by an infotainment button or slider setting on the infotainment display 708, or by a physical button or slider setting on the instrument panel 702. This may also be accomplished by voice command. This may also be accomplished via the steering wheel (e.g., by slight rotation of the steering wheel for a predetermined period of time, etc.). The system may also enable the driver to indicate if the lane keeping centering offset is desired or no longer desired. In various implementation, the pilot assist functionality describe herein may also be automated to some extent based on route selection. In an offset configuration, the system may enable vehicle sensors and safety margins to be recalibrated for more rapid safety alerts and responses as less physical space to the side of an observed lane becomes available. The system may implement similar functions with respect to pilot assist in snowy or wet conditions, as described above.

While various embodiments are described herein in the context of the road condition alert 710 being displayed on the infotainment display 708, in some embodiments, the system 104 may also present the road condition alert 710 on a heads up display (not shown) that the system 104 may present on the windshield 704 of the vehicle 102.

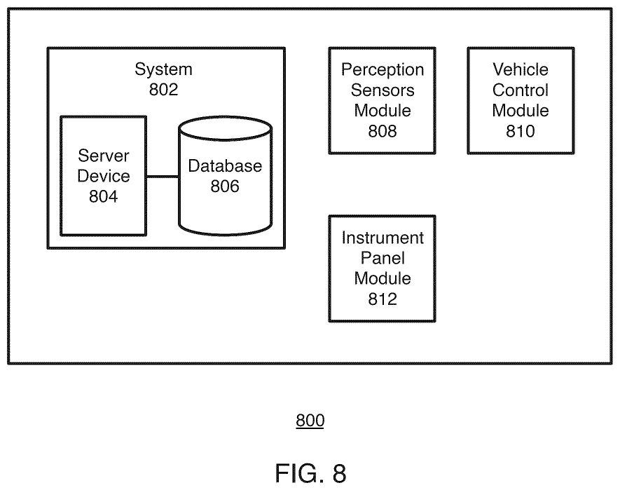

FIG. 8 is a block diagram of an example high-level architecture 800 for providing a customized pilot assist. Shown is a system 802, which may be used to implement the system 104 of FIG. 1. The system 802 includes a server device 804 and a database 806. Also shown is a perception sensors module 808, a vehicle control module 810, and an instrument panel module 812. The perception sensors module 808, the vehicle control module 810, and the instrument panel module 812 may be implemented using a combination of hardware and software. In various embodiments, the software may include and execute any suitable AI model, including any AI, machine learning, and computer vision techniques to track the observed lane and other road associated elements such as potentially hazardous object or obstacles near the observed lane, road switchbacks, etc. The system may utilize the AI model to perform various vehicle skewing actions described herein.

The system 802 communicates data signals and control signals with the perception sensors module 808, the vehicle control module 810, and the instrument panel module 812 via the server device 804. The database 806 may be used to store various types of information such as information associated with the observed lane and other road associated elements such as object or obstacles near the observed lane, road switchbacks, etc., as well as AI training information, for example.

The system 802 enables the perception sensors module 808 to control and communicate data to and from the perception sensors of the vehicle 102 to detect and track the observed lane and other road associated elements such as object or obstacles near the observed lane, road switchbacks, etc. The system 802 also enables the vehicle control module 810 to autonomously control and communicate data to various systems of the vehicle 102 to perform a variety of skewing actions, as described herein. The system 802 also enables the instrument panel module 812 to control and communicate data and information to the infotainment system. For example, system 802 enables the instrument panel module 812 to control information displayed on the infotainment display to alert the driver of any needed skewing and reasons for the skewing.

Embodiments described herein have numerous benefits. For example, embodiments enable a system of a vehicle to detect and identify potential road hazards such as object or obstacles near the observed lane, as well as more difficult driving conditions such as the presence of road switchbacks. Embodiments skew a vehicle from a center lane position to a safer skewed lane position on an observed lane for safer travel.

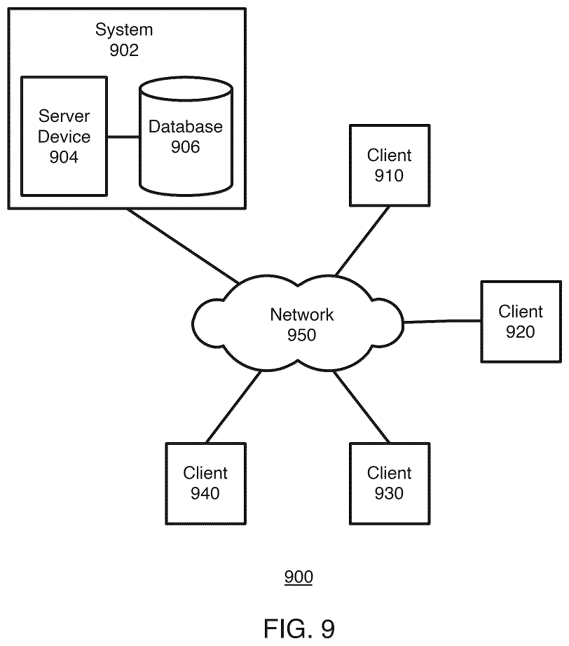

FIG. 9 is a block diagram of an example network environment 900 of the present disclosure. In some embodiments, network environment 900 includes a system 902, which includes a server device 904 and a database 906. In various embodiments, system 902 may be used to implement system 102 of FIG. 1 and/or system 802 of FIG. 8, as well as to perform embodiments described herein. Network environment 900 also includes client devices 910, 920, 930, and 940, which may communicate with system 902 and/or may communicate with each other directly or via system 902. The client devices 910, 920, 930, and 940 may be used to implement the perception sensors, the infotainment system, other systems associated with the vehicle. Network environment 900 also includes a network 950 through which system 902 and client devices 910, 920, 930, and 940 communicate. Network 950 may be any suitable communication network such as a Wi-Fi network, Bluetooth network, the Internet, etc.

For ease of illustration, FIG. 9 shows one block for each of system 902, server device 904, and network database 906, and shows four blocks for client devices 910, 920, 930, and 940. Blocks 902, 904, and 906 may represent multiple systems, server devices, and network databases. Also, there may be any number of client devices. In other embodiments, environment 900 may not have all of the components shown and/or may have other elements including other types of elements instead of, or in addition to, those shown herein.

While server device 904 of system 902 performs embodiments described herein, in other embodiments, any suitable component or combination of components associated with system 902 or any suitable processor or processors associated with system 902 may facilitate performing the embodiments described herein.

In the various embodiments described herein, a processor of system 902 and/or a processor of any client device 910, 920, 930, and 940 cause the elements described herein (e.g., information, etc.) to be displayed in a user interface on one or more display screens.

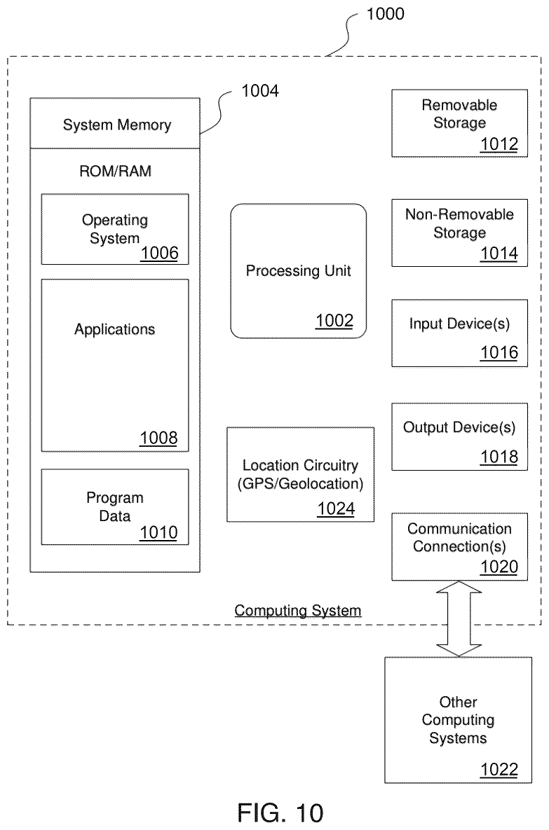

FIG. 10 is a block diagram of an example computing system 1000 of the present disclosure. The computing system 1000 may be used to implement the system 102 of FIG. 2 and/or system 802 of FIG. 8 and/or system 902 of FIG. 9, as well as to perform embodiments described herein.

The computing system 1000 typically includes at least one processing unit 1002 and a system memory 1004. Depending on the particular configuration and type of computing device, the system memory 1004 may be volatile such as random-access memory (RAM), non-volatile such as read-only memory (ROM), flash memory, and the like, or some combination of volatile memory and non-volatile memory. The system memory 1004 typically maintains an operating system 1006, one or more applications 1008, and program data 1010. The operating system 1006 may include any number of operating systems executable on desktops or portable devices including, but not limited to, Linux, Microsoft Windows®, Apple OS®, or Android®.

The computing system 1000 may also have additional features or functionality. For example, the computing system 1000 may also include additional data storage devices (removable and/or non-removable) such as, for example, magnetic disks, optical disks, tape, or flash memory. Such additional storage may include removable storage 1012 and non-removable storage 1014. Computer storage media may include volatile and non-volatile, removable and non-removable media implemented in any method or technology for storage of information, such as computer-readable instructions, data structures, program modules or other data. The system memory 1004, the removable storage 1012, and the non-removable storage 1014 are all examples of computer storage media. Available types of computer storage media include, but are not limited to, RAM, ROM, EEPROM, flash memory (in both removable and non-removable forms) or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing system 1000. Any such computer storage media may be part of the computing system 1000.

The computing system 1000 may also have input device(s) 1016 such as a keyboard, mouse, pen, voice input device, touchscreen input device, etc. Output device(s) 1018 such as a display, speakers, printer, short-range transceivers such as a Bluetooth transceiver, etc., may also be included. The computing system 1000 also may include one or more communication connections 1020 that allow the computing system 1000 to communicate with other computing systems 1022, such as over a wired or wireless network or via Bluetooth (a Bluetooth transceiver may be regarded as an input/output device and a communications connection). The one or more communication connections 1020 are an example of communication media. Available forms of communication media typically carry computer-readable instructions, data structures, program modules or other data in a modulated data signal such as a carrier wave or other transport mechanism and include any information delivery media. The term “modulated data signal” may include a signal that has one or more of its characteristics set or changed in such a manner as to encode information in the signal. By way of illustrative example only and not of limitation, communication media may include wired media such as a wired network or direct-wired connection, and wireless media such as acoustic, radio frequency (RF), infrared and other wireless media. The term computer-readable media as used herein includes both storage media and communication media.

The computing system 1000 may also include location circuitry 1024. In various embodiments, the location circuitry 1024 may include circuitry including global positioning system (GPS) circuitry and/or geolocation circuitry. The location circuitry 1024 may automatically discern its location based on relative positions to multiple GPS satellites and/or triangulation using cellular carrier network(s) and/or IEEE Standard 802.11 wireless (Wi-Fi) networks (collectively referred to as “geolocation services”) to determine location based on multiple cellular communications facilities and/or multiple Wi-Fi networks. The location circuitry 1024, including GPS circuitry and/or geolocation circuitry, is frequently incorporated in smartphones and many other tablets or other portable devices. In various embodiments, computing system 1000 may not have all of the components shown and/or may have other elements including other types of components instead of, or in addition to, those shown herein.

Although the present disclosure is illustrated and described herein with reference to illustrative embodiments and specific examples provided, it will be readily apparent to those of ordinary skill in the art that other embodiments and examples may perform similar functions and/or achieve like results. All such equivalent embodiments and examples are within the spirit and scope of the present disclosure and are intended to be covered by the following non-limiting claims for all purposes.

What is claimed is:

1. A vehicle comprising:
at least one perception sensor coupled to the vehicle; and
a system comprising one or more processors and logic encoded in one or more non-transitory computer-readable storage media for execution by the one or more processors and when executed operable to cause the one or more processors to perform operations comprising:
capturing data on an external environment using the at least one perception sensor, wherein the data comprises an observed lane on which the vehicle is traveling;
computing position information of the vehicle relative to the observed lane; and
skewing a position of the vehicle relative to a center of the observed lane based on one or more skewing policies.

2. The vehicle of claim 1, wherein the logic when executed is further operable to cause the one or more processors to perform operations comprising:
detecting at least one object that is positioned on a side of the observed lane based on the data that is captured; and
estimating a location of the at least one object relative to the side of the observed lane, wherein at least one skewing policy of the one or more skewing policies comprises skewing the position of the vehicle off of the center of the observed lane and away from the at least one object based on a distance of the at least one object from the side of the observed lane.

3. The vehicle of claim 1, wherein at least one skewing policy of the one or more skewing policies comprises skewing the position of the vehicle off of the center of the observed lane and away from at least one object that is positioned on a side of the observed lane, and wherein the at least one object is one or more of a hazardous object, a construction zone, a barrier, and a person.

4. The vehicle of claim 1, wherein the logic when executed is further operable to cause the one or more processors to perform operations comprising:
detecting at least one road switchback ahead of the vehicle; and
determining road switchback characteristics of the at least one road switchback, wherein at least one skewing policy of the one or more skewing policies comprises skewing the position of the vehicle off of the center of the observed lane and toward an inside of a curve of the observed lane based on the road switchback characteristics.

5. The vehicle of claim 1, wherein the logic when executed is further operable to cause the one or more processors to perform operations comprising:
detecting at least one road switchback ahead of the vehicle; and
determining road switchback characteristics of the at least one road switchback, wherein the road switchback characteristics comprise one or more of a road curvature and a road grade.

6. The vehicle of claim 1, wherein the logic when executed is further operable to cause the one or more processors to perform operations comprising receiving route information in association with a starting point and a destination point of vehicle, and wherein at least one skewing policy of the one or more skewing policies comprises skewing the position of the vehicle off of the center of the observed lane based on the route information.

7. The vehicle of claim 1, wherein at least one skewing policy of the one or more skewing policies comprises skewing the position of the vehicle off of the center of the observed lane based on one or more road conditions.

8. A non-transitory computer-readable storage medium with program instructions stored thereon, the program instructions when executed by one or more processors are operable to cause the one or more processors to perform operations comprising:
capturing data on an external environment using the at least one perception sensor coupled to the vehicle, wherein the data comprises an observed lane on which the vehicle is traveling;
computing position information of the vehicle relative to the observed lane; and
skewing a position of the vehicle relative to a center of the observed lane based on one or more skewing policies.

9. The computer-readable storage medium of claim 8, wherein the instructions when executed are further operable to cause the one or more processors to perform operations comprising:
detecting at least one object that is positioned on a side of the observed lane based on the data that is captured; and
estimating a location of the at least one object relative to the side of the observed lane, wherein at least one skewing policy of the one or more skewing policies comprises skewing the position of the vehicle off of the center of the observed lane and away from the at least one object based on a distance of the at least one object from the side of the observed lane.

10. The computer-readable storage medium of claim 8, wherein at least one skewing policy of the one or more skewing policies comprises skewing the position of the vehicle off of the center of the observed lane and away from at least one object that is positioned on a side of the observed lane, and wherein the at least one object is one or more of a hazardous object, a construction zone, a barrier, and a person.

11. The computer-readable storage medium of claim 8, wherein the instructions when executed are further operable to cause the one or more processors to perform operations comprising:
detecting at least one road switchback ahead of the vehicle; and
determining road switchback characteristics of the at least one road switchback, wherein at least one skewing policy of the one or more skewing policies comprises skewing the position of the vehicle off of the center of the observed lane and toward an inside of a curve of the observed lane based on the road switchback characteristics.

12. The computer-readable storage medium of claim 8, wherein the instructions when executed are further operable to cause the one or more processors to perform operations comprising:
detecting at least one road switchback ahead of the vehicle; and
determining road switchback characteristics of the at least one road switchback, wherein the road switchback characteristics comprise one or more of a road curvature and a road grade.

13. The computer-readable storage medium of claim 8, wherein the instructions when executed are further operable to cause the one or more processors to perform operations comprising receiving route information in association with a starting point and a destination point of vehicle, and wherein at least one skewing policy of the one or more skewing policies comprises skewing the position of the vehicle off of the center of the observed lane based on the route information.

14. The computer-readable storage medium of claim 8, wherein at least one skewing policy of the one or more skewing policies comprises skewing the position of the vehicle off of the center of the observed lane based on one or more road conditions.

15. A computer-implemented method for providing a customized pilot assist, the method comprising:
capturing data on an external environment using the at least one perception sensor coupled to the vehicle, wherein the data comprises an observed lane on which the vehicle is traveling;
computing position information of the vehicle relative to the observed lane; and
skewing a position of the vehicle relative to a center of the observed lane based on one or more skewing policies.

16. The method of claim 15, further comprising:
detecting at least one object that is positioned on a side of the observed lane based on the data that is captured; and
estimating a location of the at least one object relative to the side of the observed lane, wherein at least one skewing policy of the one or more skewing policies comprises skewing the position of the vehicle off of the center of the observed lane and away from the at least one object based on a distance of the at least one object from the side of the observed lane.

17. The method of claim 15, wherein at least one skewing policy of the one or more skewing policies comprises skewing the position of the vehicle off of the center of the observed lane and away from at least one object that is positioned on a side of the observed lane, and wherein the at least one object is one or more of a hazardous object, a construction zone, a barrier, and a person.

18. The method of claim 15, further comprising:
detecting at least one road switchback ahead of the vehicle; and
determining road switchback characteristics of the at least one road switchback, wherein at least one skewing policy of the one or more skewing policies comprises skewing the position of the vehicle off of the center of the observed lane and toward an inside of a curve of the observed lane based on the road switchback characteristics.

19. The method of claim 15, further comprising:
detecting at least one road switchback ahead of the vehicle; and
determining road switchback characteristics of the at least one road switchback, wherein the road switchback characteristics comprise one or more of a road curvature and a road grade.

20. The method of claim 15, wherein the logic when executed is further operable to cause the one or more processors to perform operations comprising receiving route information in association with a starting point and a destination point of vehicle, and wherein at least one skewing policy of the one or more skewing policies comprises skewing the position of the vehicle off of the center of the observed lane based on the route information.
